(19) United States
(12) Patent Application Publication
(10) Pub. No.: US 2016/0026769 A1
(43) Pub. Date: Jan. 28, 2016

(54) Facilitating Establishment of a Virtual Medical Consultation Session

(71) Applicant: Carepics, LLC, Wilmington, DE (US)

(72) Inventors: Terry Williams, Raleigh, NC (US); Paul Edward Schubert, Raleigh, NC (US)

(21) Appl. No.: 14/873,764

(22) Filed: Oct. 2, 2015

Related U.S. Application Data
(63) Continuation-in-part of application No. PCT/US2014/033472, filed on Apr. 9, 2014.
(60) Provisional application No. 61/853,634, filed on Apr. 9, 2013.

(51) Int. Cl. G06F 19/00

(52) U.S. Cl. CPC G06F 19/3425; G06F 19/322; G06F 19/3418

(57) ABSTRACT

A network server facilitates establishment of a virtual medical consultation session between a requestor and a clinical assessment team member. The network server receives, from the requestor, a request for a virtual medical consultation that specifies a clinical assessment team comprising a plurality of clinical assessment team members, and sends an availability query to the plurality of clinical assessment team members in the clinical assessment team. The network server then receives one or more availability responses from the plurality of clinical assessment team members, each availability response indicating the availability of a corresponding clinical assessment team member. The network server then sends an availability score to the requestor, the availability score being calculated from the availability responses and indicating an overall availability of the clinical assessment team. An end-user device of the requestor communicates with the network server to also facilitate establishment of the virtual medical consultation session.

### RELATED APPLICATIONS

The present application is a Continuation-in-Part of International Application No. PCT/US2014/033472, filed Apr. 9, 2014 and entitled “PROTECTING PATIENT INFORMATION IN VIRTUAL MEDICAL CONSULTATIONS”, which claims the benefit of U.S. Provisional Application No. 61/853,634, filed Apr. 9, 2013 and entitled “REAL TIME VIRTUAL CLINICAL IMAGERY TECHNOLOGY”, the disclosures of all of which are expressly incorporated by reference herein in their entirety.

### TECHNICAL FIELD

The present invention relates generally to virtual medical consultations, and more particularly to facilitating establishment of a virtual medical consultation session between a requestor and a clinical assessment team member within a healthcare delivery network that supports virtual medical consultations.

### BACKGROUND

The electronic distribution of patient information is regulated under the Health Insurance Portability and Accountability Act of 1996 (“HIPAA”) and further supported by the Balanced Budget Act of 1997. HIPAA mandates heightened requirements for maintaining the confidentiality of patient records under the Centers for Medicare and Medicaid Services in dealing with clinical information and data. One of the important principles under HIPAA is that patient files, imagery or notes may not be shared with third parties not directly involved with the clinical care of the patient, and any such sharing must be done with the consent of the patient. Internet-based collaborative software, such as video chat and image sharing, offers great promise in making medical experts from around the world available for consultation at a moment's notice. However, the use of such software in collaborative electronic healthcare systems must be compliant with the confidentiality requirements of HIPAA and other regulations. This applies to any such system that stores patient information. Accordingly, a need exists for collaborative electronic healthcare systems that protect patient information and adhere to HIPAA and other regulations, such as state medical licensing requirements, malpractice policy coverage, insurance reimbursement coverage, and others.

### SUMMARY OF THE PRESENT INVENTION

In exemplary embodiments of the present disclosure, a network server facilitates establishment of a virtual medical consultation session between a requestor and a clinical assessment team member. The network server receives, from the requestor, a request for a virtual medical consultation that specifies a clinical assessment team comprising a plurality of clinical assessment team members, and sends an availability query to the plurality of clinical assessment team members in the clinical assessment team. The network server then receives one or more availability responses from the plurality of clinical assessment team members, each availability response indicating the availability of a corresponding clinical assessment team member. The network server then sends an availability score to the requestor, the availability score being calculated from the availability responses and indicating an overall availability of the clinical assessment team. An end-user device of the requestor communicates with the network server to facilitate establishment of the virtual medical consultation session.

Exemplary embodiments of the disclosure comprise methods, implemented in a network server of a healthcare delivery network, for facilitating establishment of a virtual medical consultation session between a requestor and a clinical assessment team member. In an exemplary embodiment, the method comprises receiving, from the requestor, a request for a virtual medical consultation that specifies a clinical assessment team comprising a plurality of clinical assessment team members. The method further comprises sending an availability query to the plurality of clinical assessment team members in the clinical assessment team, and receiving one or more availability responses from the plurality of clinical assessment team members, each availability response indicating the availability of a corresponding clinical assessment team member. The method further comprises sending an availability score to the requestor, the availability score being calculated from the availability responses and indicating an overall availability of the clinical assessment team.

Other embodiments comprise methods, implemented in an end-user device of a requestor, for facilitating establishment of a virtual medical consultation session between the requestor and a clinical assessment team member. In an exemplary embodiment, the method comprises sending, to a network server, a request for a virtual medical consultation that specifies a clinical assessment team comprising the plurality of clinical assessment team members, and receiving an availability score from the network server that indicates an overall availability of the clinical assessment team. The method further comprises requesting that the network server establish a session for the virtual medical consultation with one of the plurality of clinical assessment team members.

Other embodiments comprise a network server of a healthcare delivery network. In an exemplary embodiment, the network server comprises communications circuitry for exchanging signals with the healthcare delivery network, and processing circuitry communicatively coupled to the communications circuitry. The processing circuitry is configured to receive, from a requestor via the communications circuitry, a request for a virtual medical consultation that specifies a clinical assessment team comprising a plurality of clinical assessment team members. The processing circuitry is further configured to send an availability query to the plurality of clinical assessment team members in the clinical assessment team via the communications circuitry, and receive one or more availability responses from the plurality of clinical assessment team members via the communications circuitry, each availability response indicating the availability of a corresponding clinical assessment team member. The processing circuitry is further configured to send an availability score to the requestor via the communications circuitry, the availability score being calculated from the availability responses and indicating an overall availability of the clinical assessment team.

Other embodiments comprise an end-user device of a requestor. In an exemplary embodiment, the network server comprises communications circuitry for exchanging signals with the healthcare delivery network, and processing circuitry communicatively coupled to the communications circuitry. The processing circuitry is configured to send, to a network server via the communications circuitry, a request for a virtual medical consultation that specifies a clinical assessment team comprising a plurality of clinical assessment team members. The processing circuitry is further configured to receive an availability score from the network server via the communications circuitry that indicates an overall availability of the clinical assessment team, and request, via the communications circuitry, that the network server establish a session for the virtual medical consultation with one of the plurality of clinical assessment team members.

Other embodiments include computer program products stored in non-transitory computer readable media for controlling programmable hardware, the computer program products comprising software instructions which, when run on their respective programmable hardware, causes the programmable hardware to perform one or more of the above-described methods.

### BRIEF DESCRIPTION OF THE DRAWINGS

FIG. 1 illustrates an exemplary healthcare delivery network according to various embodiments of the present disclosure.

FIG. 2 illustrates a virtual medical consultation according to various embodiments of the present disclosure.

FIG. 3 illustrates messaging within the healthcare delivery network for facilitating establishment of a virtual medical consultation session, according to various embodiments of the present disclosure.

FIG. 4 illustrates messaging within the healthcare delivery network for establishing the virtual medical consultation session, according to various embodiments of the present disclosure.

FIG. 5 illustrates an exemplary method, implemented in a network server, for facilitating establishment of a virtual medical consultation session, according to various embodiments of the present disclosure.

FIG. 6 illustrates a more detailed exemplary method, implemented in a network server, for facilitating establishment of a virtual medical consultation session, according to various embodiments of the present disclosure.

FIG. 7 illustrates an exemplary method, implemented in an end-user device of a requestor, for facilitating establishment of a virtual medical consultation session, according to various embodiments of the present disclosure.

FIG. 8 illustrates a more detailed exemplary method, implemented in an end-user device of a requestor, for facilitating establishment of a virtual medical consultation session, according to various embodiments of the present disclosure.

FIG. 9 illustrates exemplary hardware useful for implementing one or more of the requestor device and the network server, according to various embodiments of the present disclosure.

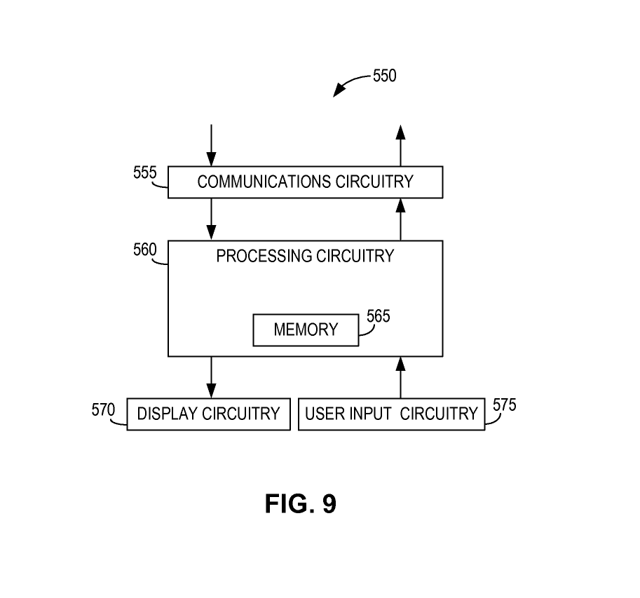

### DETAILED DESCRIPTION

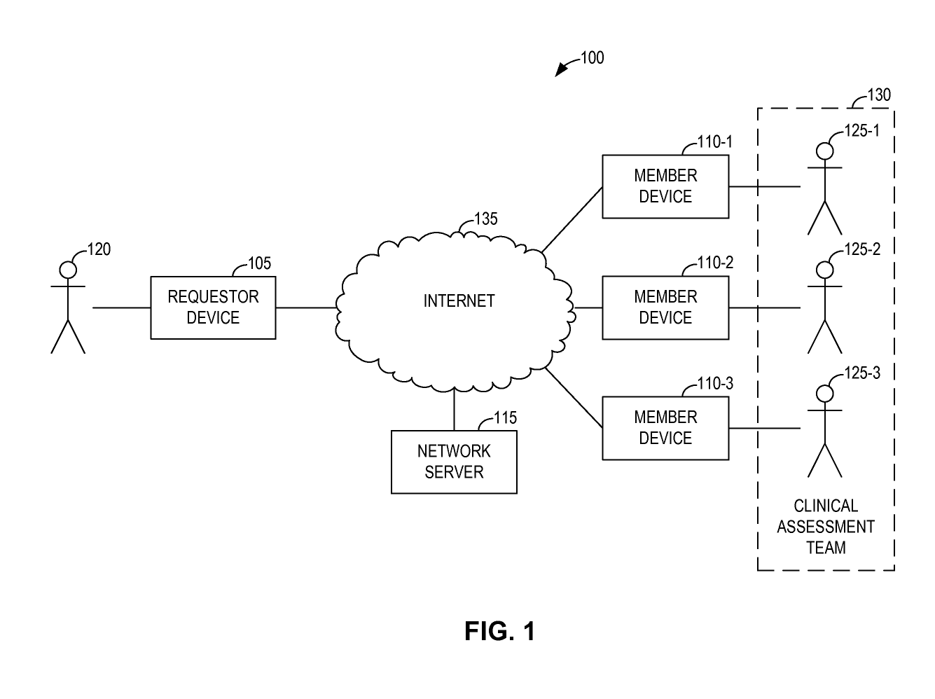

FIG. 1 illustrates an exemplary healthcare delivery network 100 that allows end-user devices 105, 110 to communicate with each other. The healthcare delivery network 100 includes end-user devices 105, 110 that are each connected to a network server 115, and to each other, via the Internet 135 or other physical network. The example healthcare delivery network 100 supports multiple users 120, 125. In particular, requestor 120 is a user of requestor device 105, and clinical assessment team members 125-1, 125-2, 125-3 are users of member devices 110-1, 110-2, 110-3. Note that, as used herein, when a reference numeral comprises a numerical sub-designation in the drawings, discussion of a specific instance of an illustrated element will use the appropriate corresponding sub-designation (e.g., the member device 110-1 corresponding to clinical assessment team member 125-1). However, the sub-designation will be omitted in order to refer generically to the illustrated subject matter (e.g., discussion of a member device 110 (generally), rather than discussion of particular member devices 110-1, 110-2, 110-3).

Examples of the end-user devices 105, 110 include smart phones, tablets, personal computers, laptops, and medical workstations. These end-user devices 105, 110 are generally able to execute software, interface directly with respective local users, and communicate with each other over the Internet 135. Some of these communications flow through network server 115. In other of these communications, an end-user device 105, 110 and the network server 115 are the endpoints.

Requestor 120 may be a patient or a caretaker, such as a licensed clinical practitioner or registered nurse, who is attending to a particular patient. Clinical assessment team members 125 are members of a clinical assessment team 130. These clinical assessment team members 125 are licensed medical professionals, but are not necessarily responsible for the patient. A clinical assessment team 130 can be any plurality of members 125. For example, a clinical assessment team 130 can include certain members 125 known to network server 115 who share a particular medical specialization. A clinical assessment team 130 can include members 125 with whom requestor 120 has an established professional relationship. Thus, a clinical assessment team 130 can be defined by the requestor 120, or may be configured on the network server 115. In all cases, however, members 125 of the clinical assessment team 130 are permitted to access protected health information. Protected health information includes the medical records of a patient, such as health, treatment, and payment records that can be attributed to that patient.

Network servers are generally useful for providing network services and centrally storing important data. Within healthcare delivery network 100, implementing these network services and providing access to protected health information is complicated by regulations that impose heightened requirements for protecting patient confidentiality. These regulations, such as the Health Insurance Portability and Accountability Act of 1996 (HIPAA), make it improper to share information with sources other than those directly involved with the clinical care of a patient. Therefore, network server 115, in order to participate in the healthcare delivery network 100, controls access to clinical information that would identify a patient in a manner that complies with the regulations. These regulations may be imposed by federal, state, or local governments, or by private entities such as private hospitals, clinicians, and patients. Examples of network server 115 include a mainframe, a rack server, a blade server, a server cluster, and a cloud server.

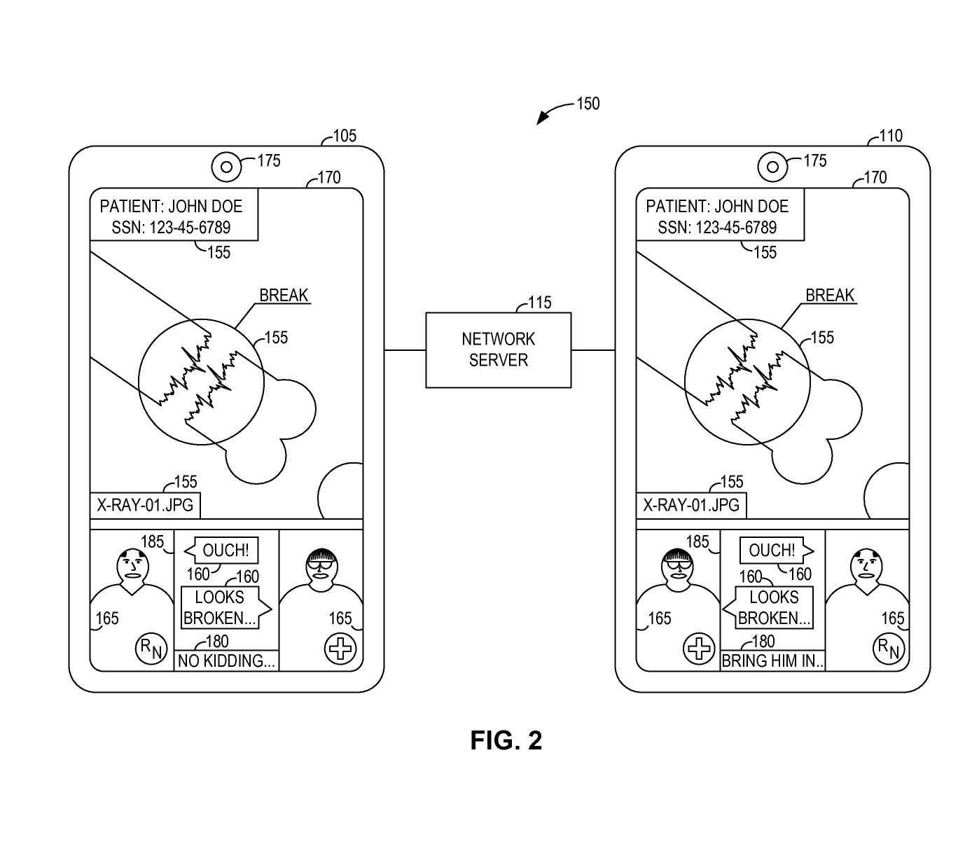

One of the network services that network server 115 can provide is establishing sessions to support virtual medical consultations 150, such as the one illustrated in FIG. 2. A virtual medical consultation session allows a requestor 120 to obtain an image 170 and share that image 170 with a clinical assessment team member 125 in a manner that complies with regulations (HIPAA in particular). Accordingly, such sessions are controlled by network server 115 in a private fashion. Network server 115 may require parties to the session to authenticate, encrypt any protected health information 170 that is transmitted, or otherwise safeguard the session from snooping by third-parties. Requestor 120 can use this session to send protected health information 170, such as images, video, patient records, or combinations thereof, to a clinical assessment team member via network server 115. In this way, both the requestor device 105 and the member device 110 are able to present the protected health information at the same time, despite any geographic distance that may be between them.

If the protected health information 170 includes an image or video, the image or video may be acquired by the requestor device 105 directly using a camera 175 or other imaging device. If the protected health information 170 includes a patient record, the patient record can be acquired directly via user input into the requestor device 105. The user input accepted by the requestor device 105 include entering text via a software or hardware keyboard, making selections via a pointing device or touchscreen, giving speech commands, and entering gestures through a touch or optical recognition interface. Protected health information 170 can also be acquired by the requestor device 105 via external storage communicatively connected to the requestor device. Examples of such external storage include a Secure Digital card, Universal Serial Bus flash drive, CompactFlash, external hard disk, and network attached storage.

During the session established by network server 115, requestor device 105 can exchange other information with member device 110 during the virtual medical consultation session, such as video conference data 165, voice communications, graphical annotations 155, and text chat messages 160. Voice communications can be exchanged via Voice Over IP, cellular telecommunications, Wi-Fi, or Plain Old Telephone Service. Video conference data 165 can be acquired via camera 175 and presented on the end-user devices 105, 110 simultaneously with the protected health information 170. Graphical annotations 155, such as drawings, highlighting, and text, can be entered on either of the end-user devices 105, 110, and presented on both as an overlay upon, or near, the protected health information 170. Text chat messages 160 can be entered into a text entry area 180 and presented in a conversation transcript area 185 of each end-user device's 105, 110 display. This exchange of other information can be exchanged through network server 115, as part of the virtual medical consultation session, or can be exchanged through a parallel communication path that is also secured, or deemed adequate with respect to the aforesaid regulations.

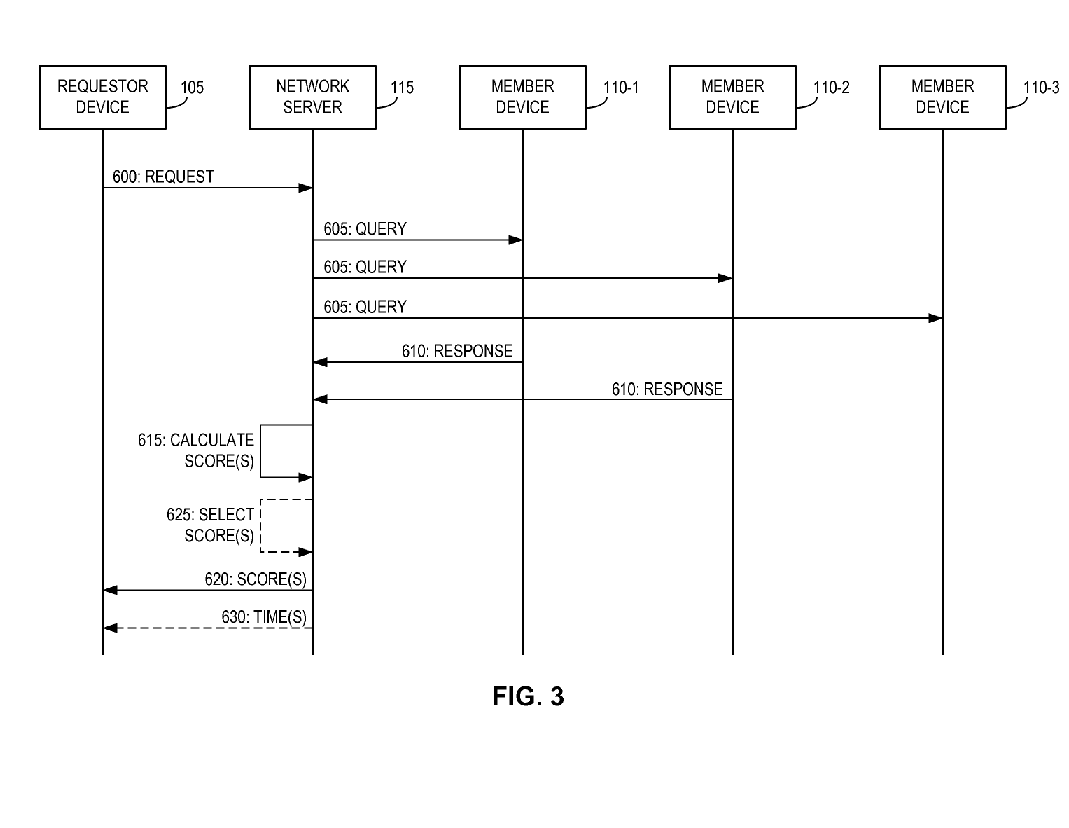

It may be necessary or advantageous to obtain a virtual medical consultation 150 with a clinical assessment team member 125 in a manner that considers the overall availability of the clinical assessment team 130. Accordingly, FIG. 3 illustrates messaging within the healthcare delivery network for facilitating establishment of a virtual medical consultation session between a requestor 120 and a clinical assessment team member 125 such that the overall availability of the clinical assessment team 130 is considered. As shown in FIG. 3, network server 115 receives, from requestor device 105, a request for a virtual medical consultation 150 (step 600). The request specifies a clinical assessment team 130 comprising a plurality of clinical assessment team members 125-1, 125-2, 125-3. The clinical assessment team members 125-1, 125-2, 125-3 may be preconfigured at the network server 115 as being part of the clinical assessment team 130. Alternatively, one or more of the clinical assessment team members 125-1, 125-2, 125-3 may be, or may have been, added to the clinical assessment team 130 in response to one or more corresponding identifiers sent to the network server 115 from the requestor device 105. These identifiers, corresponding to the clinical assessment team members 125, may be included in the request for the virtual medical consultation 150, for example. The one or more identifiers may be used by the network device 115 to resolve the identities of individual clinical assessment team members 125. Examples of such an identifier include an email address, phone number, team identifier, user name and legal name of a team member 125. Only clinical assessment team members 125 that are permitted to access protected health information 170 will be added to the clinical assessment team 130.

The network server 115 sends an availability query to each member device 110-1, 110-2, 110-3, corresponding to the clinical assessment team members 125-1, 125-2, 125-3, in the clinical assessment team 130 (step 605). The network server 115 then receives one or more availability responses from the member devices 110 (step 610). Each availability response received from a respective member device 110 indicates the availability of a corresponding clinical assessment team member 125.

For example, member device 110-1, having received the availability query, displays a prompt for clinical assessment team member 125-1 to indicate when he or she will be available for a virtual medical consultation 150. Clinical assessment team member 125-1 then responds to the prompt by indicating a present or future time that may be convenient, and the member device 110-1 responds to the network server 115 accordingly.

Not all of the member devices 110 necessarily respond to the availability query in the same manner, or for that matter, respond at all. For example, member device 110-2, having received the availability query, may automatically access an electronic calendar and responds to the availability query with a plurality of times that are open in the schedule of clinical assessment team member 110-2. Additionally or alternatively, member device 110-2 may respond to the availability query with a location of the corresponding clinical assessment team member 125-2. This location may be used to determine the availability of the corresponding clinical assessment team member 125-2. For example, clinical assessment team member 125-2 may only be licensed to practice medicine in (or may have malpractice insurance that only covers activities performed within) a limited geographic area. As another example, the requestor 120 may be a patient whose medical insurance policy will only reimburse the requestor 120 for activities performed within a limited geographic area. In such examples, the network server 115 may determine that the location of clinical assessment team member 125-2 is outside of a relevant geographic area, and in response, determine that clinical assessment team member 125-2 is unavailable. Thus, the network server 115 may take into account one or more scheduling, regulatory, and/or economic factors in determining an extent to which a clinical assessment team member 125 is available.

Further, according to the example illustrated in FIG. 3, network server 115 receives no availability response from member device 110-3 at all. There are many reasons why no response may have been received from member device 110-3. For example, network device 115 may be configured to only wait for a threshold period of time for member devices 110 to respond. Such a threshold may be important if a virtual medical consultation 150 is urgently needed. Accordingly, member device 110-3 may have taken too long to provide its availability response. Alternatively, the clinical assessment team member 125-3 may have purposefully ignored, or dismissed, a prompt for his or her availability that was displayed on the member device 110-3, such that member device 110-3 was unable to provide an availability response. Alternatively, the availability response may have been dropped or delayed while in transit through the Internet 135. Thus, while the network server 115 receives availability responses from all of the member devices 110 in some embodiments, according to the embodiment illustrated in FIG. 3 the network server 115 only receives availability responses from member devices 110-1 and 110-2 (but not 110-3).

The network device 115 calculates an availability score from the availability responses (step 615). The availability score indicates an overall availability of the clinical assessment team. For example, the availability score may be positively influenced by availability responses from clinical assessment team members 125 that responded that they are available, or would be available in the future. The availability score may, on the other hand, be negatively influenced by not having received an availability response from one or more clinical assessment team members 125, or by determining that one or more clinical assessment team members 125 is unavailable (e.g., due to being out of an insurance coverage area and/or out of a medical licensing area, as discussed above).

In addition, the availability score may indicate a probability that at least one of the plurality of clinical assessment team members is available at a particular time. Thus, the availability score may indicate that there is a thirty-percent chance that a clinical assessment team member 125 is presently available. Alternatively, the availability score may indicate that there is a moderate chance that a clinical assessment team member 125 will be available after ten minutes have elapsed. The network device then sends the availability score to the requestor device 105 (step 620). This availability score allows the requestor 120 the opportunity to consider the overall availability of the clinical assessment team before confirming to the network server 115 that a session for the virtual medical consultation 150 is desired.

In some embodiments, the availability score sent to the requestor device 105 is one of a plurality of candidate scores calculated by the network server 115. For example, the availability responses received from the member devices 110 may indicate several times in which the clinical assessment team members 125 are available. Accordingly, the network server 115 may calculate a first candidate score indicating a probability that at least one of the plurality of clinical assessment team members 125 is available for the virtual medical consultation 150 at a present time, and a second candidate score indicating a probability that at least one of the plurality of clinical assessment team members 125 will be available for the virtual medical consultation 150 at a future time. The network server 115 may then select, based on the probabilities and the respective times, a candidate score to send to the requestor device 105 as the availability score (step 625).

For example, the network server 115 may weigh the benefit of an increased probability of being available at a future time against the cost of deferring the virtual medical consultation 150 until that future time. In such an example, the network device 115 may select the second candidate score (corresponding to the future time) if a short wait will substantially increase the probability that a clinical assessment team member 125 will be available. Alternatively, if the probability that a clinical assessment team member 125 will be available only increases by a small amount, or if a substantial wait is required in order for availability to significantly increase, the network server 115 may select the first candidate score (corresponding to a present time). Accordingly, the candidate score that the network server 115 selects may be a function of the availability score and the corresponding wait required, in which both of these factors are independently weighted (e.g., weighted according to the needs of the requestor 120 and/or according to the configuration of the network server 115).

Depending upon which candidate score the network server 115 selects as the availability score, the network server 115 may send the corresponding time to the requestor device 105 as a recommended time to establish a session for the virtual medical consultation 150 (step 630). In some embodiments, the network device 115 only sends a single availability score and corresponding recommended time to the requestor device 105. In other embodiments, the network device 115 also sends, to the requestor device 105, one or more alternatives to the recommended time (along with the candidate score(s) corresponding thereto).

For example, the network device 115 may additionally select a further candidate score, based on the respective probabilities and times of the candidate scores that have been calculated. The network device 115 may then send the further candidate score, along with its corresponding time, to the requestor device 105 as an alternative to the recommended time. This may, for example, allow the requestor 120 to judge, according to his or her circumstances, whether the recommended time or the alternative time is a more attractive option for the virtual medical consultation session. Indeed, the requestor 120 may even decide that the availability of clinical assessment team 130 is too low, and may decide to abandon any attempt to establish a session with a member 125 of that team 130. For example, the requestor 120 may send another request for a virtual medical consultation 150 that specifies a different clinical assessment team.

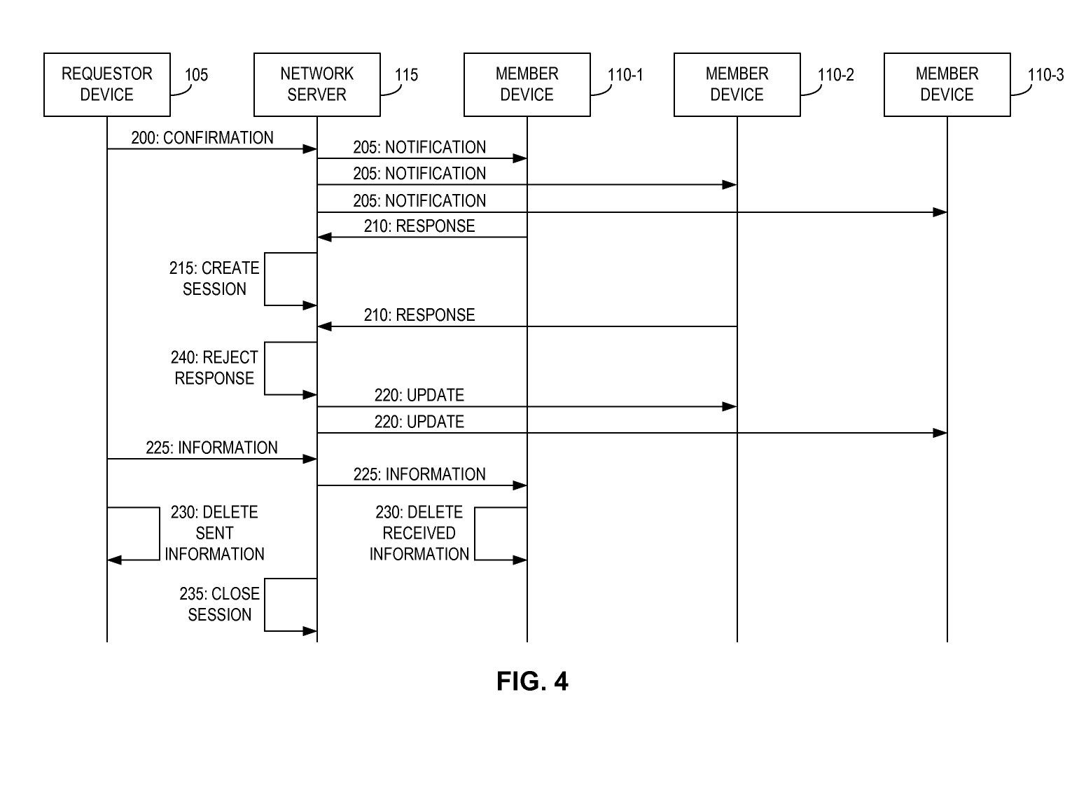

Having considered the overall availability of the clinical assessment team 130, the requestor 120 may wish to actually establish a session with a virtual medical consultation team member 125, e.g., at a time of the requestor's choosing. Accordingly, FIG. 4 illustrates messaging within the healthcare delivery network, for establishing a virtual medical consultation session between the requestor device 105 and a member device 110 according to a first-to-respond, first-to-treat protocol. Requestor device 105 first sends a confirmation to establish a session for the virtual medical consultation 150 to network server 115 (step 200). In response, network server 115 sends, to at least two of the clinical assessment team members 125, a notification indicating that a session for the virtual medical consultation 150 has been requested (step 205).

In some embodiments, the network server 115 sends a notification to each of the clinical assessment team members 125 in the clinical assessment team 130. In other embodiments, the network server 115 excludes one or more of the clinical assessment team members 125 from being notified that the session has been requested. For example, the network server 115 may exclude a clinical assessment team member 125 from being notified that the session has been requested in response to determining that the clinical assessment team member 125 is unavailable for the session. There are many reasons why a clinical assessment team member 125 may be determined to be unavailable by the network server 115. For example, the clinical assessment team member 125 may have been determined to be located outside a particular insurance policy coverage area, as discussed above. Alternatively, the clinical assessment team member 125 may have responded to the availability query by indicating that he or she would not be available for the session.

Of the clinical assessment team members 125 that receive the notification, one or more respond to this notification, using their respective member devices 110, as being available (step 210). Network server 115, having received at least one response, establishes a virtual medical consultation session for the requestor 120 and the first clinical assessment team member 125-1 to respond as being available (step 215). Because regulations require that access to the protected health information 170 shared in the virtual medical consultation session be limited to those involved with the clinical care of a patient, the late response from member device 110-2, received after the session is established, is rejected (step 240). The rejection may be in the form of a silent discard of the subsequent response, or may be in the form of an explicit reply that optionally also includes the reason for the rejection, according to embodiments. Network server 115, having established the virtual medical consultation session between requestor device 105 and the first member device 110-1 that responded to the notification, sends, to the clinical assessment team members 125-2, 125-3 not in the virtual medical consultation session, an update indicating that participation in the virtual medical consultation 150 is not needed (step 220). This update informs the member devices 110-2, 110-3 not in the virtual medical consultation session to “stand down” with regard to any further responses.

Requestor device 105, being in the virtual medical consultation session with member device 110-1 and no other member devices 110-2, 110-3, can now send protected health information 170 to member device 110-1 via network server 115 (step 225). The two devices 105, 110-1 then exchange video conference data 165, voice communications, graphical annotations 155, and/or text chat messages 160 with reference to the protected health information 170 (and which itself may be protected health information 170). This information exchange clinical assessment team member 125-1 to provide a reasoned medical opinion to the requestor 120.

During the virtual medical consultation session, the end-user devices 105, 110-1 participating in the session, and the network server 115, will generate an alert in response to detecting that a copy of the protected health information 170 has been made. If the copying is detected by an end-user device 105, 110-1, generating the alert includes sending the alert to at least one of the other end-user device 105, 110-1 in the session, the network server 115, and an administrator of the healthcare delivery network 100. The end-user device 105, 110-1 that detects the copying can also delete the copy of the protected health information 170. If the network server 115 receives an alert that a copy of the protected health information 170 has been made by a participant 105, 110-1 in the virtual medical consultation session, the network server 115 will, in response, alert at least one of the requestor 120, the first clinical assessment team member 125-1, and an administrator of the healthcare delivery network.

Because requestor device 105 and member device 110-1 may be the personal devices of requestor 120 and clinical assessment team member 125-1, or might otherwise be insecure, it is important that protected health information 170 not be allowed to remain unsecured on those devices. Accordingly, requestor device 105 and member device 110-1 will delete the protected health information 170 on their respective devices 105, 110-1 in response to detecting that the respective end-user device 105, 110-1 will no longer participate in the virtual medical consultation session (step 230). Alternatively, the end-user devices 105, 110-1 may store the protected health information 170 in a secure memory in which access is tightly controlled, instead of deleting the protected health information, according to embodiments.

Detecting that the end-user device 105, 110-1 will no longer participate in the virtual medical consultation session can include detecting a loss of connection to the network server 115, receiving a termination signal from the other device 105, 110-1 or network server 115, or may be due to voluntarily leaving the session. At the end of the virtual medical consultation 150, network server 115 closes the session (step 235). Although the requestor device 105 and member device 110-1 delete the protected health information 170, the network server 115 may or may not also delete the information. For example, network server 115 may be administered in such fashion as to maintain compliance with privacy regulations. Accordingly, the protected health information 170 may be retained at the network server 115, such as to maintain the accuracy of the patient's records, bill the patient for the consultation 150, or memorialize what was discussed during the virtual medical consultation 150. If the network server 115 retains the protected health information 170, the protected health information 170 may be encrypted and stored in a secure fashion.

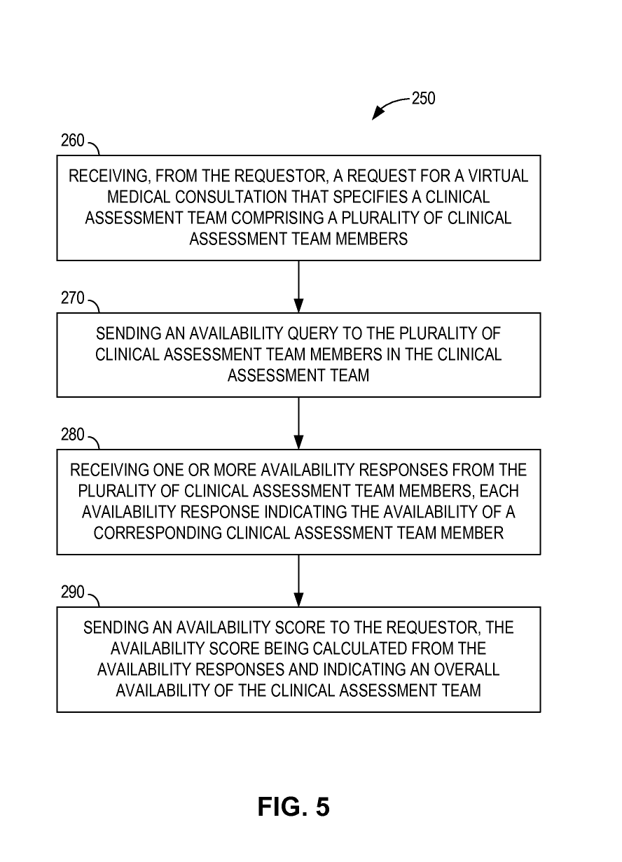

FIG. 5 illustrates an example method 250, implemented in a network server 115 of a healthcare delivery network 100, for facilitating establishment of a virtual medical consultation session between a requestor 120 and a clinical assessment team member 125. The method 250 comprises receiving, from the requestor 120, a request for a virtual medical consultation 150 that specifies a clinical assessment team 130 comprising a plurality of clinical assessment team members 125 (block 260). The method 250 further comprises sending an availability query to the plurality of clinical assessment team members 125 in the clinical assessment team 130 (block 270), and receiving one or more availability responses from the plurality of clinical assessment team members 125, each availability response indicating the availability of a corresponding clinical assessment team member 125 (block 280). The method 250 further comprises sending an availability score to the requestor 120, the availability score being calculated from the availability responses and indicating an overall availability of the clinical assessment team 130 (block 285).

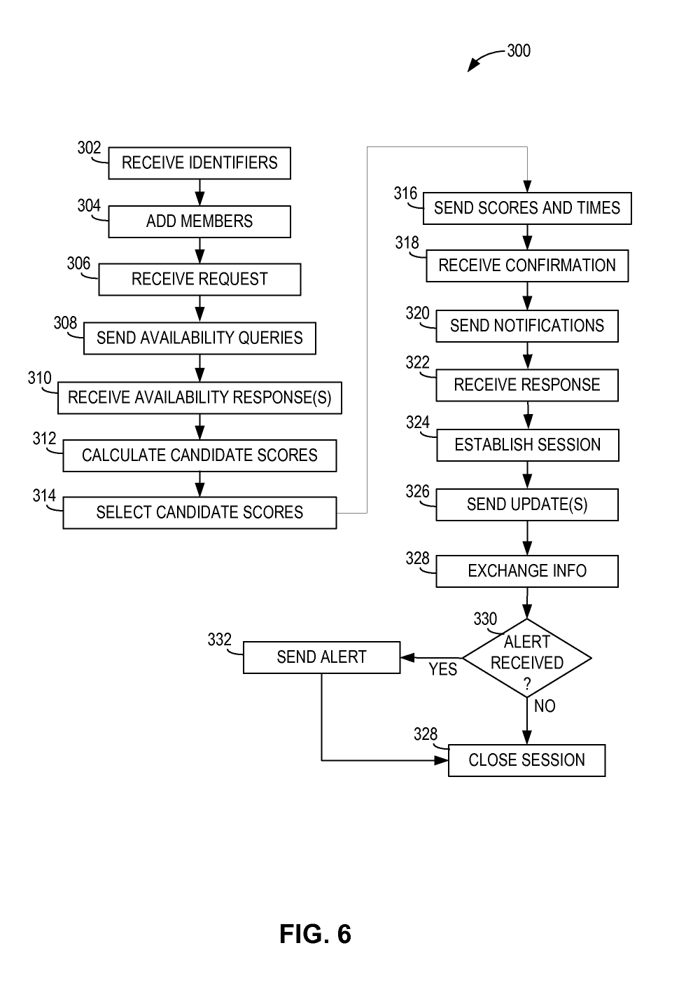

FIG. 6 illustrates a more detailed method 300, implemented in a network server 115 of a healthcare delivery network 100, for facilitating establishment of a virtual medical consultation session between a requestor 120 and a clinical assessment team member 125. First, the network server 115 receives one or more identifiers from the requestor 120 that are associated with one or more clinical assessment team members 125 (block 302). The network server 115 adds the clinical assessment team members 125 corresponding to the one or more identifiers to a clinical assessment team 130 (block 304). The network server 115 then receives a request for a virtual medical consultation 150 that specifies the clinical assessment team 130 (block 306). In response, the network server 115 sends availability queries to the clinical assessment team members 125 in the clinical assessment team 130 (block 308).

The network server 115 subsequently receives one or more availability responses in response to the availability queries (block 310), which the network server 115 uses to calculate candidate scores, each candidate score indicating a probability that at least one of the plurality of clinical assessment team members 125 will be available at a respective time, as discussed above (block 312). The network server 115 selects, based on the probabilities and respective times, a candidate score that corresponds to a recommended time to establish a session for the virtual medical consultation 150, and a further candidate score that corresponds to an alternative time to establish the session for the virtual medical consultation 150 (block 314). The network server 115 then sends the selected scores and corresponding times to the requestor 120 (block 316).

The network device 115 then receives a confirmation to establish a session for the virtual medical consultation 150 from the requestor 120 (block 318). In response, the network server 115 sends a notification to the member devices 110 corresponding to the clinical assessment team members 125 on the clinical assessment team 130 (block 320). The network server 115 then receives a response to the notification (block 322) and establishes a session for the requestor and the responding clinical assessment team member 125 (block 324).

Now that the session has been established between the requestor 120 and a clinical assessment team member 125, the network server 115 sends an update to the clinical assessment team members 125 not in the session, directing them to stand down from the previous notification, and indicating that participation in the virtual medical consultation 150 is not needed (block 326). The network server 115 will then receive protected health information 170 from the requestor 120 and send that protected health information 170 to the clinical assessment team member 125 in the session (block 328). If the network server 115 receives an alert that a copy of the protected health information 170 has been made by a participant in the virtual medical consultation session (block 330), the network server 115 will send the alert to at least one of the requestor 120, the clinical assessment team member 125 in the session, and an administrator of the healthcare delivery network 100 (block 332). Regardless of whether an alert is received, the network server 115 will ultimately close the session (block 328).

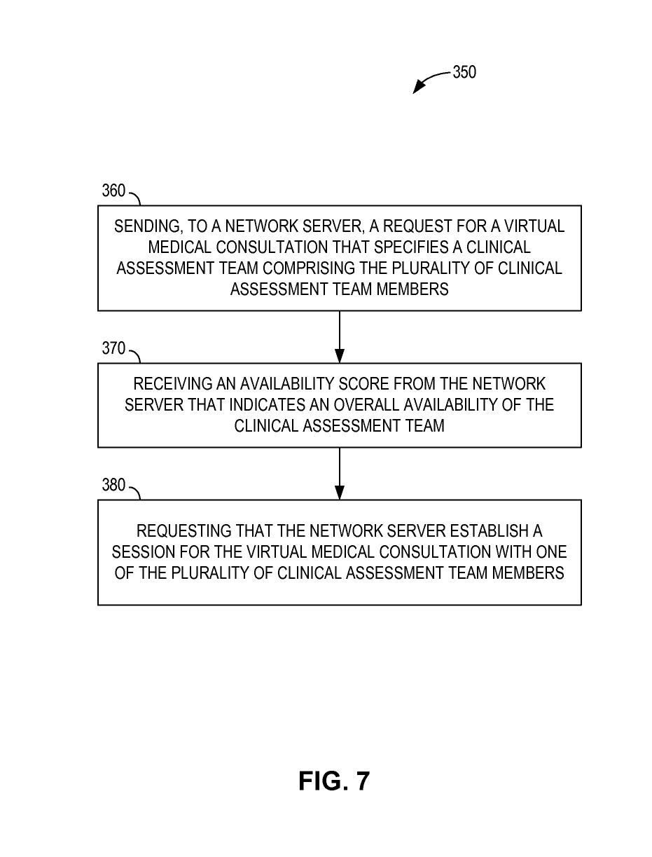

FIG. 7 illustrates an example method 350, implemented in an end-user device 105 of a requestor 120, for facilitating establishment of a virtual medical consultation session between the requestor 120 and a clinical assessment team member 125. The method 350 comprises sending, to a network server 115, a request for a virtual medical consultation 150 that specifies a clinical assessment team 130 comprising the plurality of clinical assessment team members 125 (block 360), and receiving an availability score from the network server 115 that indicates an overall availability of the clinical assessment team 130 (block 370). The method 350 further comprises requesting that the network server 115 establish a session for the virtual medical consultation 150 with one of the plurality of clinical assessment team members 125 (block 380).

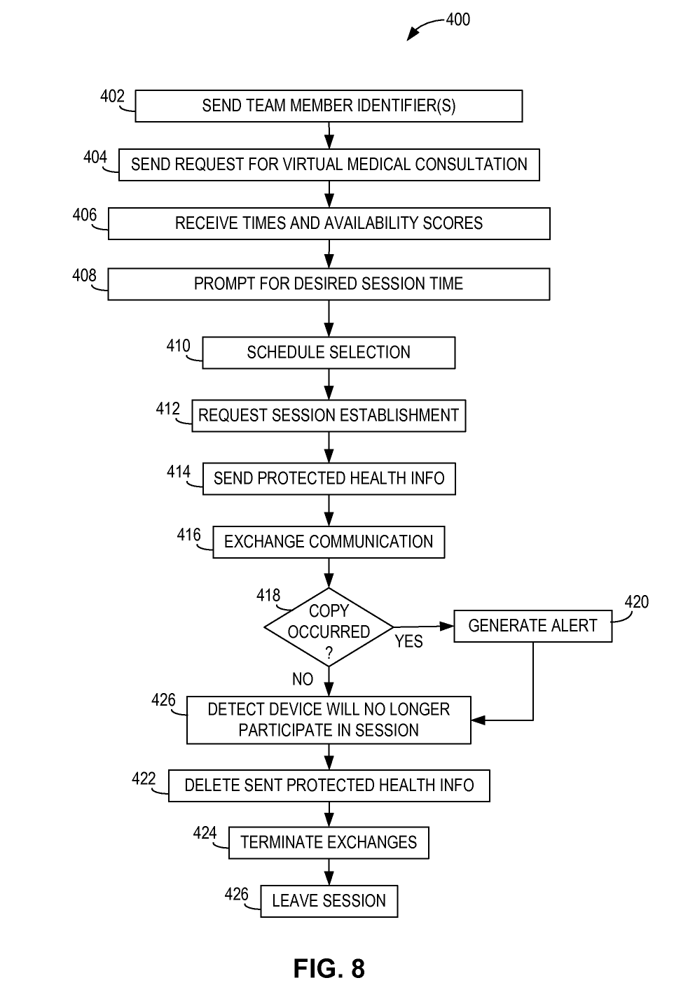

FIG. 8 illustrates a more detailed method 400, implemented in an end-user device 105 of a requestor 120, for facilitating establishment of a virtual medical consultation session between the requestor 120 and a clinical assessment team member 125. The requestor device 105 sends one or more identifiers associated with a plurality of clinical assessment team members 125 to the network server 115 to request that the network server 115 add the plurality of clinical assessment team members 125 to the clinical assessment team 130 (block 402). Examples of such identifiers identify clinical assessment team members 125 with particularity, such as by specifying a name or e-mail address of a particular clinical assessment team member 125. Additionally or alternatively, these identifiers indicate a group or team identifier that corresponds to several clinical assessment team members 125 at once. Additionally or alternatively, these identifiers specify attributes about the clinical assessment team members 125 that would be acceptable for the virtual medical consultation 150. For example, the requestor 120 could indicate a medical specialty, such as cardiology, or surgery, within a 100 mile radius, and the network server 115 would resolve the one or more identifiers to particular clinical assessment team members 125 to add to the team 130.

The requestor device 105 will then send a request for a virtual medical consultation 150 that specifies the clinical assessment team (block 404). In response, the requestor device 105 receives a plurality of times and corresponding availability scores from the network server 115 (block 406). The plurality of times includes a recommended time to establish a session for the virtual medical consultation 150, as well as an alternative time to establish the session. As previously discussed, the availability scores indicate a probability that at least one of the plurality of clinical assessment team members 125 is available for the virtual medical consultation 150 at the corresponding time.

The requestor device 105 prompts the requestor 120 for a time to establish the session using one or more received times and scores (block 408). For example, the requestor device 105 prompts the requestor 120 as whether the requestor 120 would like to establish the session at the recommended time or at the alternative time. The requestor device 105 may additionally allow the requestor 105 to specify a time of the requestor's choosing. The requestor device 105 then schedules, at the time selected by the requestor 120, establishing the session and/or an alarm to remind the requestor 120 of the selected time for the session (block 410).

The requestor device 105 requests that the network server 115 establish a session for the virtual medical consultation 150 with one of the plurality of clinical assessment team members 125, e.g., at one of the received times (block 412). Once the session is established, the requestor device 105 sends protected health information 170 to a member device 110 of the clinical assessment team member 125 in the session, e.g., via the network server 115 (block 414). The device 105 then exchanges one or more of voice communications, video conference data 165, graphical annotations 155, and text chat messages 160 with the clinical assessment team member 125 in the session so that he or she can provide a medical opinion for the particular medical issue at hand (block 416).

If the device 105 detects that a copy of the protected health information 170 has been made (block 418), the device 105 will generate an alert (block 420). This alert will be sent to at least one of the clinical assessment team member 125 in the session, the network server 115, and an administrator of the healthcare delivery network 100. Whether or not copying occurs, device 105 will eventually detect that it will no longer participate in the virtual medical consultation session (block 426). In response, device 105 deletes the sent protected health information 170 (block 422), terminates any other communication exchanges within the session between the parties (block 424), and leaves the session (block 426).

Although the above describes the requestor device 105 sending team member identifiers so that the network server 115 can add corresponding clinical assessment team members 125 to the clinical assessment team 130, according to other embodiments, the clinical assessment team 130 may be fixed or preconfigured at the network server 115. Further, although the above describes the requestor device 105 receiving a plurality of times and corresponding availability scores, other embodiments include the requestor device 105 receiving only a single availability score and not receiving any corresponding time. Thus, the network server 115 may provide an availability score that corresponds to an implied time (e.g., the present time) or a time indicated by the requestor 120 (e.g., as specified in the requestor's request for the consultation 150).

FIG. 11 illustrates exemplary hardware 550 useful for implementing one or more of the requestor device 105 and network server 115 disclosed herein. The hardware 550 comprises communications circuitry 555 useful for exchanging messages over a network with other computing devices. The hardware 550 further comprises processing circuitry 560 operatively connected to the communications circuitry 555. The processing circuitry comprises a non-transitory, physical memory 565, and is also operatively connected to display circuitry 570 and user input circuitry 575. The display circuitry 570 is useful to output signals to be viewed by a user of the hardware 550. For example, the display circuitry 570 may be comprised within one or more of a graphics adapter, a graphical processing unit, a display port, a Liquid Crystal display, a Light Emitting Diode display, a plasma display, a front projector, and a rear projection television. The user input circuitry 575 is useful to accept input signals from the user of hardware 550. For example, the user input circuitry 575 may be comprised within one or more of a pointing device (such as a mouse, stylus, touchpad, trackball, pointing stick, joystick), a touchscreen, a microphone for speech input, an optical sensor for optical recognition of gestures, and a keyboard.

When hardware 550 is used to implement the network server 115, the processing circuitry 560 is configured to receive, from a requestor via the communications circuitry 555, a request for a virtual medical consultation 150 that specifies a clinical assessment team 130 comprising a plurality of clinical assessment team members 125. The processing circuitry 560 is further configured to send an availability query to the plurality of clinical assessment team members 125 in the clinical assessment team 130 via the communications circuitry 555, and receive one or more availability responses from the plurality of clinical assessment team members 125 via the communications circuitry 555. Each availability response indicates the availability of a corresponding clinical assessment team member 125. The processing circuitry 560 is further configured to send an availability score to the requestor 120 via the communications circuitry 555, the availability score being calculated from the availability responses and indicating an overall availability of the clinical assessment team 130. The display circuitry 570 and user input circuitry 575 may, for example, be useful to a network administrator in preconfiguring the plurality of clinical assessment team members 125 on the clinical assessment team 130. Although the above illustrates communications circuitry 555 that is distinct from the display and user input circuitry 570, 575, according to embodiments, the display circuitry 570 and user input circuitry 575 are part of the communications circuitry 555, such that display and input functions of the hardware 550 are provided to a remote user over the Internet 135.

When hardware 550 is used to implement the requestor device 105, the processing circuitry 560 is configured to send, to a network server 115 via the communications circuitry 555, a request for a virtual medical consultation 150 that specifies a clinical assessment team 130 comprising a plurality of clinical assessment team members 125. The processing circuitry 560 is further configured to receive an availability score from the network server 115 via the communications circuitry 555 that indicates an overall availability of the clinical assessment team 130, and request, via the communications circuitry 555, that the network server 115 establish a session for the virtual medical consultation 150 with one of the plurality of clinical assessment team members 125. The user input circuitry 575 are configured to accept input from the requestor 120 for exchanging communications with the clinical assessment team member 125 during the virtual medical consultation 150, as discussed above. The display circuits 570 are configured to display communications from the clinical assessment team member 125 in the session during the virtual medical consultation 150, as discussed above.

Those skilled in the art will appreciate that the various methods and processes described herein may be implemented using various hardware configurations that generally, but not necessarily, include the use of one or more microprocessors, microcontrollers, digital signal processors, or the like, coupled to memory storing software instructions or data for carrying out the techniques described herein. In particular, those skilled in the art will appreciate that the circuits of various embodiments of the router may be configured in ways that vary in certain details from the broad descriptions given above. For instance, one or more of the processing functionalities discussed above may be implemented using dedicated hardware, rather than a microprocessor configured with program instructions. Such variations, and the engineering tradeoffs associated with each, will be readily appreciated by the skilled practitioner. Since the design and cost tradeoffs for the various hardware approaches, which may depend on system-level requirements that are outside the scope of the present disclosure, are well known to those of ordinary skill in the art, further details of specific hardware implementations are not provided herein.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention.

What is claimed is:

1. A method, implemented in a network server of a healthcare delivery network, for facilitating establishment of a virtual medical consultation session between a requestor and a clinical assessment team member, the method comprising:
receiving, from the requestor, a request for a virtual medical consultation that specifies a clinical assessment team comprising a plurality of clinical assessment team members;
sending an availability query to the plurality of clinical assessment team members in the clinical assessment team;
receiving one or more availability responses from the plurality of clinical assessment team members, each availability response indicating the availability of a corresponding clinical assessment team member;
sending an availability score to the requestor, the availability score being calculated from the availability responses and indicating an overall availability of the clinical assessment team.

2. The method of claim 1, wherein the availability score further indicates a probability that at least one of the plurality of clinical assessment team members is available for the virtual medical consultation at a present time.

3. The method of claim 1, wherein the availability score further indicates a probability that at least one of the plurality of clinical assessment team members will be available for the virtual medical consultation at a future time.

4. The method of claim 1, further comprising:
calculating a plurality of candidate scores from the availability responses, each candidate score indicating a probability that at least one of the plurality of clinical assessment team members is available for the virtual medical consultation at a respective time;
selecting a candidate score based on the probabilities and respective times to send as the availability score;
sending the time corresponding to the selected candidate score to the requestor as a recommended time to establish a session for the virtual medical consultation.

5. The method of claim 4, further comprising:
selecting a further candidate score based on the probabilities and respective times;
sending, to the requestor:
the further candidate score;
the time corresponding to the further candidate score as an alternative to the recommended time to establish the session for the virtual medical consultation.

6. The method of claim 1, further comprising adding the plurality of clinical assessment team members to the clinical assessment team based on one or more identifiers, received from the requestor, that are associated with the plurality of clinical assessment team members.

7. The method of claim 1, further comprising:
receiving, from the requestor, a confirmation to establish a session for the virtual medical consultation;
notifying at least two clinical assessment team members in the plurality of clinical assessment team members that the session has been requested;
establishing the session for the requestor and one clinical assessment team member that responds to the notification as being available for the session;
sending, to the notified clinical assessment team members not in the session, an update indicating that participation in the virtual medical consultation is not needed.

8. The method of claim 7, further comprising rejecting a subsequent response from a late clinical assessment team member, the subsequent response having been received after the session has been established.

9. The method of claim 7, further comprising:
receiving an alert that a participant in the session has made a copy of protected health information exchanged in the session; and
sending the alert to at least one of the other participant and an administrator of the healthcare delivery network.

10. The method of claim 7:
wherein receiving one or more availability responses from the plurality of clinical assessment team members comprises receiving an availability response that comprises a location of a corresponding clinical assessment team member;
further comprising, determining that the location is outside of a given geographic area, and in response:
determining that the corresponding clinical assessment team member is unavailable for the session;
excluding the corresponding clinical assessment team member from the notifying of the at least two clinical assessment team members that the session has been requested.

11. The method of claim 10, wherein the given geographic area corresponds to at least one of:
a geographic area in which the corresponding clinical assessment team member is licensed to practice medicine;
an insurance policy coverage area.

12. A method, implemented in an end-user device of a requestor, for facilitating establishment of a virtual medical consultation session between the requestor and a clinical assessment team member, the method comprising:
sending, to a network server, a request for a virtual medical consultation that specifies a clinical assessment team comprising the plurality of clinical assessment team members;
receiving an availability score from the network server that indicates an overall availability of the clinical assessment team;
requesting that the network server establish a session for the virtual medical consultation with one of the plurality of clinical assessment team members.

13. The method of claim 12, wherein the availability score further indicates a probability that at least one of the plurality of clinical assessment team members is available for the virtual medical consultation at a present time.

14. The method of claim 12, wherein the availability score further indicates a probability that at least one of the plurality of clinical assessment team members will be available for the virtual medical consultation at a future time.

15. The method of claim 12, further comprising:
receiving a plurality of times from the network server, the plurality of times comprising:
a recommended time to establish the session that corresponds to the availability score;
an alternative time to establish the session that corresponds to a further availability score;
receiving the further availability score;
wherein requesting that the network server establish the session for the virtual medical consultation with one of the plurality of clinical assessment team members comprises requesting that the network server establish the session at one of the plurality of times.

16. The method of claim 12, further comprising sending one or more identifiers associated with the plurality of clinical assessment team members to the network server to request that the network server add the plurality of clinical assessment team members to the clinical assessment team.

17. The method of claim 12, further comprising:
exchanging protected health information with the clinical assessment team member in the established session;
receiving an alert that the clinical assessment team member in the established session has made a copy of the protected health information.

18. A network server of a healthcare delivery network comprising:
communications circuitry for exchanging signals with the healthcare delivery network;
processing circuitry communicatively coupled to the communications circuitry and configured to:
receive, from a requestor via the communications circuitry, a request for a virtual medical consultation that specifies a clinical assessment team comprising a plurality of clinical assessment team members;
send an availability query to the plurality of clinical assessment team members in the clinical assessment team via the communications circuitry;
receive one or more availability responses from the plurality of clinical assessment team members via the communications circuitry, each availability response indicating the availability of a corresponding clinical assessment team member;
send an availability score to the requestor via the communications circuitry, the availability score being calculated from the availability responses and indicating an overall availability of the clinical assessment team.

19. The network server of claim 18, wherein the availability score further indicates a probability that at least one of the plurality of clinical assessment team members is available for the virtual medical consultation at a present time.

20. The network server of claim 18, wherein the availability score further indicates a probability that at least one of the plurality of clinical assessment team members will be available for the virtual medical consultation at a future time.

21. The network server of claim 18, wherein the processing circuitry is further configured to:
calculate a plurality of candidate scores from the availability responses, each candidate score indicating a probability that at least one of the plurality of clinical assessment team members is available for the virtual medical consultation at a respective time;
select a candidate score based on the probabilities and respective times to send as the availability score;
send the time corresponding to the selected candidate score to the requestor via the communications circuitry as a recommended time to establish a session for the virtual medical consultation.

22. The network server of claim 21, wherein the processing circuitry is further configured to:
select a further candidate score based on the probabilities and respective times;
send, to the requestor via the communications circuitry:
the further candidate score;
the time corresponding to the further candidate score as an alternative to the recommended time to establish the session for the virtual medical consultation.

23. The network server of claim 18, wherein the processing circuitry is further configured to add the plurality of clinical assessment team members to the clinical assessment team based on one or more identifiers, received from the requestor via the communications circuitry, that are associated with the plurality of clinical assessment team members.

24. The network server of claim 18, wherein the processing circuitry is further configured to:
receive, from the requestor via the communications circuitry, a confirmation to establish a session for the virtual medical consultation;
notify at least two clinical assessment team members in the plurality of clinical assessment team members, via the communications circuitry, that the session has been requested;
establish the session for the requestor and one clinical assessment team member that responds to the notification as being available for the session;
send, via the communications circuitry and to the notified clinical assessment team members not in the session, an update indicating that participation in the virtual medical consultation is not needed.

25. The network server of claim 24, wherein the processing circuitry is further configured to reject a subsequent response from a late clinical assessment team member, the subsequent response having been received via the communications circuitry after the session has been established.

26. The network server of claim 24, wherein the processing circuitry is further configured to:
receive an alert, via the communications circuitry, that a participant in the session has made a copy of protected health information exchanged in the session; and
send the alert, via the communications circuitry, to at least one of the other participant and an administrator of the healthcare delivery network.

27. The network server of claim 24:
wherein to receive one or more availability responses from the plurality of clinical assessment team members via the communications circuitry the processing circuitry is configured to receive an availability response that comprises a location of a corresponding clinical assessment team member;
wherein the processing circuitry is further configured to determine that the location is outside of a given geographic area, and in response:
determine that the corresponding clinical assessment team member is unavailable for the session;
exclude the corresponding clinical assessment team member from the notifying of the at least two clinical assessment team members that the session has been requested.

28. The network server of claim 27, wherein the given geographic area corresponds to at least one of:
a geographic area in which the corresponding clinical assessment team member is licensed to practice medicine;
an insurance policy coverage area.

29. An end-user device of a requestor comprising:
communications circuitry for exchanging signals with the healthcare delivery network;
processing circuitry communicatively coupled to the communications circuitry and configured to:
send, to a network server via the communications circuitry, a request for a virtual medical consultation that specifies a clinical assessment team comprising a plurality of clinical assessment team members;
receive an availability score from the network server via the communications circuitry that indicates an overall availability of the clinical assessment team;
request, via the communications circuitry, that the network server establish a session for the virtual medical consultation with one of the plurality of clinical assessment team members.

30. The end-user device of claim 29, wherein the availability score further indicates a probability that at least one of the plurality of clinical assessment team members is available for the virtual medical consultation at a present time.

31. The end-user device of claim 29, wherein the availability score further indicates a probability that at least one of the plurality of clinical assessment team members will be available for the virtual medical consultation at a future time.

32. The end-user device of claim 29:
wherein the processing circuitry is further configured to:
receive a plurality of times from the network server via the communications circuitry, the plurality of times comprising:
a recommended time to establish the session that corresponds to the availability score;
an alternative time to establish the session that corresponds to a further availability score;
receive the further availability score via the communications circuitry;
wherein to request, via the communications circuitry, that the network server establish the session for the virtual medical consultation with one of the plurality of clinical assessment team members, the processing circuitry is configured to request that the network server establish the session at one of the plurality of times.

33. The end-user device of claim 29, wherein the processing circuitry is further configured to send one or more identifiers associated with the plurality of clinical assessment team members to the network server via the communications circuitry to request that the network server add the plurality of clinical assessment team members to the clinical assessment team.

34. The end-user device of claim 29, wherein the processing circuitry is further configured to:
exchange protected health information with the clinical assessment team member in the established session via the communications circuitry;
receive an alert, via the communications circuitry, that the clinical assessment team member in the established session has made a copy of the protected health information.
